(19) United States
(12) Patent Application Publication
(10) Pub. No.: US 2013/0165292 A1
(43) Pub. Date: Jun. 27, 2013

(54) POWER TOOL WITH A DEVICE FOR SWITCHING BETWEEN A FIRST AND A SECOND TRANSMISSION STAGE BY REVERSING THE DIRECTION OF ROTATION

(71) Applicant: Hilti Aktiengesellschaft, Schaan (LI)

(72) Inventors: Peter BRUGGER, Feldkirch (AT); Josef Schittl, Thueringen (AT)

(73) Assignee: Hilti Aktiengesellshaft, Schaan (LI)

(21) Appl. No.: 13/692,365

(22) Filed: Dec. 3, 2012

(30) Foreign Application Priority Data
Dec. 23, 2011 (DE) DE102011089771.2

(51) Int. Cl. F16H 3/00

(52) U.S. Cl. CPC F16H 3/005
USPC 475/294

(57) ABSTRACT

A power tool including a drive with a drive input motor and a drive input shaft that can be rotated by the drive motor in a forward direction and in a backward direction around a drive input rotational axis, including a driven component with a drive output shaft that can be rotated in a direction of movement, including a planetary gear arranged between the drive input shaft and the drive output shaft, having several planetary gear components that are configured as a sun gear, a planet carrier, a planet wheel and a ring gear wheel, whereby the drive input shaft is non-rotatably coupled to a first planetary gear component, and including a device for switching between a first and a second transmission stage of the planetary gear.

This claims the benefit of German Patent Application DE 10 2011 089 771.2, filed Dec. 23, 2011 and hereby incorporated by reference herein.

The present invention relates to a power tool with a device for switching between a first and a second transmission stage.

Within the scope of the present invention, the term “power tool” includes all power tools that drive a work tool in only one direction of movement during the processing. Typical examples are an electric wall saw, a coring tool and a hammer drill.

### BACKGROUND

When power tools are used for processing work, different substrates that are to be worked, such as for example, wood, concrete and steel, require adapted processing parameters. Aside from the appropriate work tool, these processing parameters include, for instance, the torque and the speed at which the work tool is driven around a rotational axis. In the case of hammer drills, for example, the positioning angle of the striking mechanism is changed as a function of the substrate that is to be worked. Different rotational speeds, torques, positioning angles or other suitable parameters are achieved by different gear ratios. Mechanical switching devices are known that can be switched between a first and a second transmission stage and that are actuated manually by the user. The drawback of a few embodiments is that the power tool has to be partially dismantled in order for the mechanical switching device to be actuated.

Power tools such as electric wall saws and coring tools are mounted on guide rails or guide stands and are moved, for example, by a motor. In the case of wall saws, the user has to leave the work area during the processing due to safety reasons. Moreover, a drawback of the known switching devices in the case of wall saws is that the user cannot switch over between a first and a second transmission stage during operation, but rather, has to stop the wall saw, enter the work area, actuate the mechanical switching device, and has to then turn the wall saw back on again.

### SUMMARY OF THE INVENTION

It is an object of the present invention to provide a device for power tools for switching between a first and a second transmission stage with which the switchover between the first and the second transmission stage is configured to be as simple as possible for the user. In the case of rail-guided and stand-mounted power tools, the user should not have to enter the working area of the power tool in order to switch over between a first and a second transmission stage.

The present invention provides a power including:

a drive input means with a drive motor and a drive input shaft that can be rotated by the drive motor in a forward direction and in a backward direction around a drive input rotational axis,

a drive output device means with a drive output shaft that can be rotated in a direction of movement around a drive output rotational axis,

a planetary gear arranged between the drive input shaft and the driveoutput shaft, having several planetary gear components that are configured as a sun gear, a planet carrier, a planet wheel and a ring gear, whereby the drive input shaft is non-rotatably coupled to a first of the several planetary gear components, and

a device for switching between a first and a second transmission stage of the planetary gear having a first blocking means, a second blocking means, a first catch means, and a second catch means, whereby
the first blocking means and the first catch means are coupled to a second planetary gear component,
the second blocking means and the second catch means are coupled to a third planetary gear component,
the blocking means block the rotation of the coupled planetary gear components against the direction of movement, and
the catch means transmit the torque of the coupled planetary gear components to the drive output shaft in the direction of movement.

Switching between the first and the second transmission stage of the planetary gear is carried out by changing the direction of rotation of the drive input means. This switching modality is suitable for power tools in which the work tool is only driven in one direction of movement. The user can employ an operating means to switch the gear ratio between a first and a second transmission stage by changing the direction of rotation of the drive motor.

Preferably, the first and the second blocking means are configured as a freewheel mechanism or as a blocking pawl. Preferably, the first and the second catch means are configured as freewheel mechanisms.

### BRIEF DESCRIPTION OF THE DRAWINGS

Embodiments of the invention will be described below with reference to the drawing. The drawing does not necessarily depict the embodiments true-to-scale, but rather, the drawing—where necessary for the sake of elucidation—is shown in schematic and/or slightly distorted form. Regarding any expansion of the teaching that can be gleaned directly from the drawing, reference is hereby made to the pertinent state of the art. Here, it has to be taken into account that many modifications and changes relating to the shape and to the detail of an embodiment can be made without deviating from the general idea of the invention. The features of the invention disclosed in the description, in the drawing as well as in the claims can be essential for the refinement of the invention individually as well as in any desired combination. Moreover, all combinations of at least two of the features disclosed in the description, in the drawing and/or in the claims fall within the scope of the invention. The general idea of the invention is not limited to the exact form or detail of the preferred embodiment shown and described below nor is it limited to a subject matter that would be limited in comparison to the subject matter put forward in the claims. At given rated ranges, values that fall within the specified limits are also to be disclosed as limit values and to be used and claimed as desired. For the sake of clarity, identical or similar parts or else parts with an identical or similar function are designated by the same reference numerals below.

The following is shown:

FIG. 1 a power tool according to the invention, having a drive input means, a drive output means, a gear means with a planetary gear and a device for switching between a first and a second transmission stage by reversing the direction of rotation of the drive input means;

FIGS. 2A, 2B an embodiment of the device for switching between a first and a second transmission stage in a three-dimensional view (FIG. 2A) and in a longitudinal section along the drive input shaft and the drive outputshaft (FIG. 2B);

FIG. 3 a schematic view of the switching device of FIGS. 2A and 2B in the first transmission stage in which the drive input means is driven clockwise around a drive input rotational axis; and

FIG. 4 a schematic view of the switching device of FIGS. 2A and 2B in the second transmission stage in which the drive input means is driven counterclockwise around a drive input rotational axis.

### DETAILED DESCRIPTION

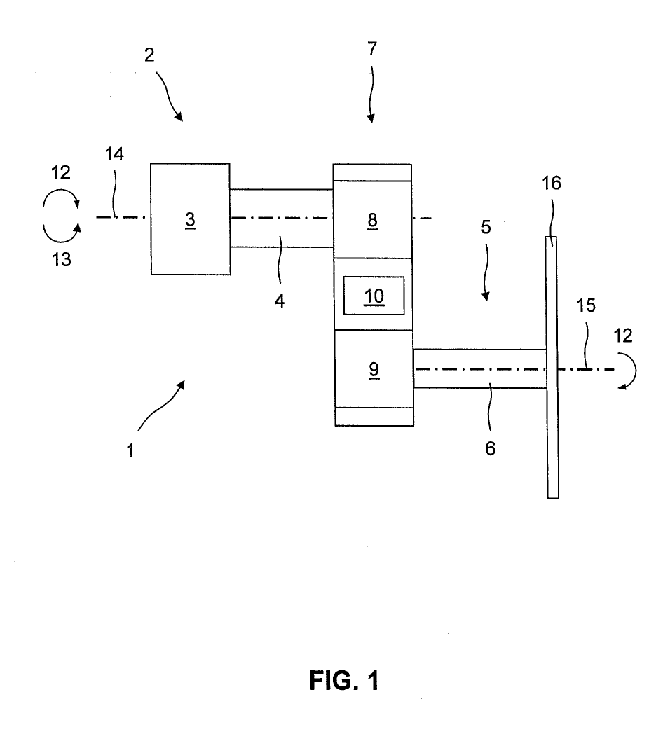

FIG. 1 shows a power tool 1 according to the invention in a schematic view. The power tool is configured, for example, as an electric wall saw, a coring tool or a hammer drill or other power tool in which the work tool is only moved in one direction.

The power tool 1 comprises a drive input means 2 with a drive motor 3 and a drive input shaft 4, a drive output means 5 with a drive output shaft 6, a gear means 7 with a planetary gear 8 and another gear unit 9 as well as a device 10 for switching between a first and a second transmission stage of the planetary gear 8. The additional gear unit 9 is used, for example, when the drive input shaft 4 and the drive output shaft 6 are not supposed to be arranged coaxially. In this case, the drive output shaft 6 can be shifted parallel to the drive input shaft, for example, by means of a spur gear.

The drive input shaft 4 is configured so that it can be rotated around a drive input rotational axis 14 by the drive motor 3 in a forward direction 12 and in a backward direction 13. The clockwise direction of rotation is defined as the forward direction 12 and the counterclockwise direction of rotation is defined as the backward direction 13. The drive output shaft 6 is rotated in the same direction of movement around a drive output rotational axis 15, irrespective of the direction of rotation 12, 13 of the drive input shaft. The direction of movement of the drive input shaft 4 corresponds to the forward direction 12 shown in FIG. 1. A work tool 16 that can be non-rotatably joined to the drive output shaft 6 is mounted on the drive output shaft 6. The work tool 16 is always rotated in the same direction of movement 12 with the drive output shaft 6, irrespective of the direction of rotation 12, 13 of the drive motor 3.

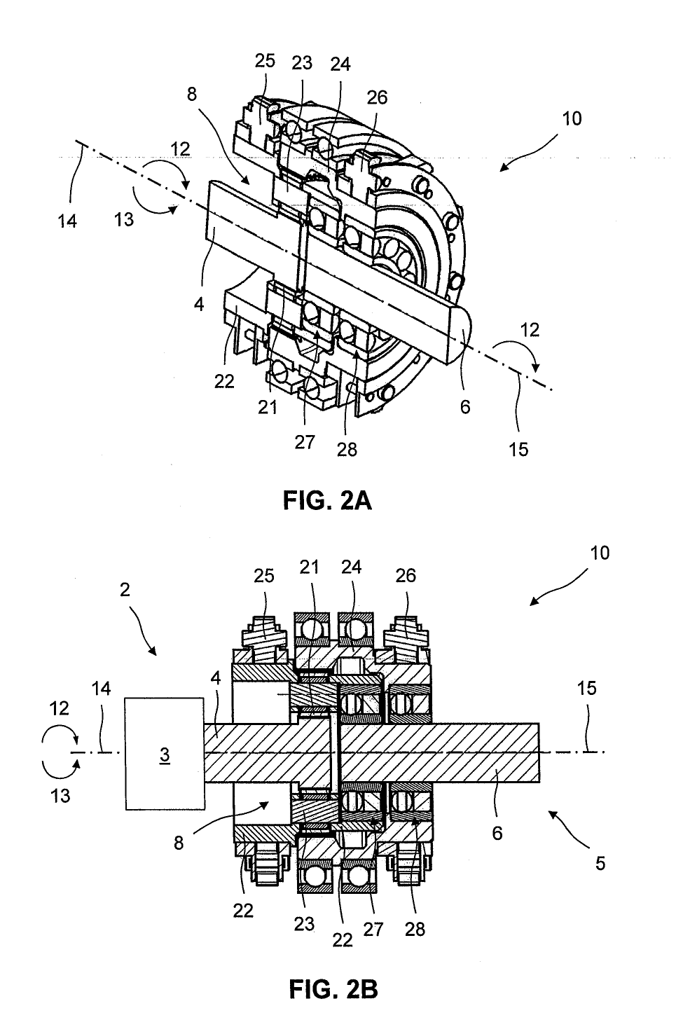

FIGS. 2A, 2B show an embodiment of the device 10 for switching between a first and a second transmission stage of the planetary gear 8 using the two directions of rotation 12, 13 of the drive input means 2. In this context, FIG. 2A shows the switching device 10 in a three-dimensional view, while FIG. 2B shows the switching device 10 in a longitudinal section along the drive input shaft 4 and the drive output shaft 6, which are arranged coaxially with respect to each other in the embodiment shown.

The planetary gear 8 is configured as a one-stage planetary gear and comprises a first center gear 21 configured as a sun gear, a planet carrier 22, several planet wheels 23 and second center gear 24 configured as a ring gear. The gear ratio between the sun gear 21 and the planet carrier 22 determines a first transmission stage of the planetary gear 8 and the gear ratio between the sun gear 21 and the ring gear 24 determines a second transmission stage. The switching between the first and the second transmission stage of the planetary gear 8 is effectuated via the two directions of rotation 12, 13 of the drive input means 2.

The switching device 10 comprises a first and a second blocking means 25, 26 as well as a first and a second catch means 27, 28. The term blocking means or block refers to a component that blocks rotational movement in a first direction of rotation and that frees it in a second direction of rotation. The term catch means or catch refers to a component that transmits rotational movement in a first direction of rotation and that freewheels in a second direction of rotation.

In the embodiment shown, the sun gear 21 is non-rotatably coupled to the drive input shaft 4. The first blocking means 25 is coupled to the planet carrier 22 and blocks the rotation of the planet carrier 22 in the backward direction 13, that is to say, the planet carrier 22 is configured so that it can be rotated in the forward direction 12 and cannot be rotated in the backward direction 13. The second blocking means 26 is coupled to the ring gear 24 and it blocks the rotation of the ring gear 24 in the backward direction 13, that is to say, the ring gear 24 is configured so that it can be rotated in the forward direction 12 and cannot be rotated in the backward direction 13.

The first catch means 27 is arranged between the planet carrier 22 and the drive output shaft 6, and it transmits the torque of the planet carrier 22 to the drive output shaft 6 in the forward direction 12. When the planet carrier 22 is rotating in the backward direction 13, the torque is not transmitted from the planet carrier 22 to the drive output shaft 6, and the planet carrier 22 freewheels. The second catch means 28 is arranged between the ring gear 24 and the drive output shaft 6, and it transmits the torque of the ring gear 24 to the drive output shaft 6 in the forward direction 12.

FIGS. 2A, 2B show an embodiment of a switching device 10 with a drive input shaft 4 that is driven by a drive motor 3, and a drive output shaft 6 that rotates the work tool 16 around the drive output rotational axis 15. As an alternative, the switching device according to the invention can be a planetary stage in a multi-stage planetary gear, whereby the switching device can be used as the first, the middle or the last planetary stage. Moreover, additional gear components, such as, for instance, a slip clutch, a spur gear, can be interconnected. These additional gear components have no influence on the idea of the invention, namely, to effectuate switching between a first and a second transmission stage via the direction of rotation of a drive means.

FIGS. 2A, B show an embodiment in which the sun gear 21 is non-rotatably coupled to the drive input shaft 4, and the blocking and catch means 25-28 are coupled to the planet carrier 22 and to the ring gear 24. Fundamentally, any planetary gear component can be non-rotatably coupled in the case of a planetary gear 8. The blocking and catch means are coupled to the additional planetary gear components and they control the torque transmission in one direction and prevent it in the other direction.

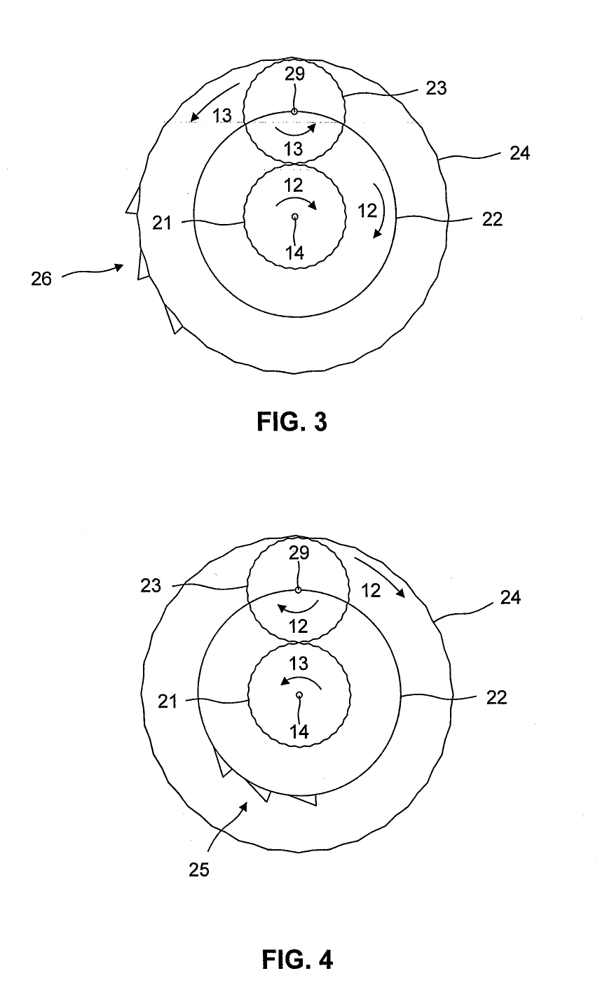

FIG. 3 shows the switching device 10 of FIGS. 2A, B in the first transmission stage in which the drive input shaft 4 is driven by the drive motor 3 in the forward direction 12 around the drive input rotational axis 14.

The torque of the drive input shaft 4 is transmitted via the non-rotatably joined sun gear 21 to the planet wheels 23 that rotate in the backward direction 13 around their rotational axis 29 and that are shifted in the ring gear 24 in the backward direction 13. Since the rotation of the ring gear 24 in the backward direction 13 is blocked by the second blocking means 26, and the planet wheels 23 are mounted in the planet carrier 22, the torque is transmitted from the planet wheels 23 to the planet carrier 22, which is rotating in the forward direction 12.

The planet carrier 22 is coupled to the drive output shaft 6 via the first catch means 27, whereby the first catch means 27 transmits the torque to the drive output shaft 6 in the forward direction 12, and it freewheels in the backward direction 13. The torque is transmitted via the first catch means 27 by the planet carrier 22 to the drive output shaft 6, which is rotating together with the work tools 16 in the forward direction 12.

FIG. 4 shows the switching device 10 of FIG. 1 in the second transmission stage in which the drive input shaft 4 of the drive motor 3 is driven in the backward direction 13 around the drive input rotational axis 14.

The torque of the drive input shaft 4 is transmitted via the non-rotatably joined sun gear 21 to the planet wheels 23 that that rotate around their rotational axis 29 in the forward direction 12. The planet wheels 23 have a tendency to shift in the ring gear 24 in the backward direction 13. Since the rotation of the planet carrier 22 in which the planet wheels 23 are mounted is blocked in the backward direction 13 by the first blocking means 25, the planet carrier 22 comes to a standstill and the torque is transmitted by the planet wheels 23 to the ringgear 24 that is rotating in the forward direction 12.

The ring gear 24 is coupled to the drive output shaft 6 via the second catch means 28, whereby the second catch means 28 transmits the torque to the drive output shaft 6 in the forward direction 12 and it freewheels in the backward direction 13. The torque is transmitted via the second catch means 28 by the ring gear 24 to the drive output shaft 6, which is rotating together with the work tool 16 in the forward direction 12.

What is claimed is:

1. A power tool comprising:
a drive input device including a drive motor and a drive input shaft rotatable by the drive motor in a forward direction and in a backward direction around a drive input rotational axis;
a drive output device including a drive output shaft rotatable in a direction of movement;
a planetary gear arranged between the drive input shaft and the drive output shaft, the planetary gear including several planetary gear components including a sun gear, a planet carrier, a planet wheel and a ring gear, the drive input shaft being non-rotatably coupled to a first of the several planetary gear components; and
a switch for switching between a first and a second transmission stage of the planetary gear, the switch including a first block and a first catch coupled to a second of the several planetary gear components, as well as a second block and a second catch coupled to a third of the several planetary gear components, the first and second blocks blocking the movement of the second and the third of several planetary gear components against the direction of movement, and the first and second catch transmitting the torque of the second and the third of the several planetary gear components to the drive output shaft in the direction of movement.

2. The power tool as recited in claim 1 wherein the first and second blocks are configured as a freewheel mechanism or as a blocking pawl.

3. The power tool as recited in claim 2 wherein the first and the second catches are configured as freewheel mechanisms.

4. The power tool as recited in claim 1 wherein the first and the second catches are configured as freewheel mechanisms.
